(19) United States
(12) Patent Application Publication
(10) Pub. No.: US 2009/0272316 A1
(43) Pub. Date: Nov. 5, 2009

(54) DEVICE FOR SPRAYING A COSMETIC COMPOSITION

(75) Inventors: Pascal ARNAUD, L'Hay Les Roses (FR); Annick COLLETTE, St. Maur Des Fosses (FR); Sophie BEAUMARD, Villejuif (FR); Nicolas DURU, Paris (FR); Marion PRUNIER, Croissy Sur Seine (FR); Pascal TIERCE, Bondues (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'Oreal S.A., Paris (FR)

(21) Appl. No.: 12/369,854

(22) Filed: Feb. 12, 2009

Related U.S. Application Data
(60) Provisional application No. 61/071,061, filed on Apr. 10, 2008.

(30) Foreign Application Priority Data
Feb. 13, 2008 (FR) 0850923

(51) Int. Cl. B05B 7/00

(52) U.S. Cl. 118/300

(57) ABSTRACT

The present invention relates to a cosmetic assembly comprising a cosmetic or dermatological composition contained in a reservoir, the said composition being liquid and comprising, in a physiologically acceptable medium, at least one pulverulent phase, and the said composition having a viscosity ranging from 5 to 500 mPa·s, and to a device for spraying the said composition, comprising a sonotrode (82) that is fed with composition via a hollow channel for feeding with product to be sprayed.

### REFERENCE TO PRIOR APPLICATIONS

This application claims priority to U.S. provisional application 61/071,061 filed Apr. 10, 2008, and to French patent application 0850923 filed Feb. 13, 2008, both incorporated herein by reference.

### FIELD OF THE INVENTION

The present invention relates to a device for spraying, in the form of a spray, a cosmetic composition comprising at least one pulverulent phase and having a specific viscosity.

Additional aspects and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Traditional makeup products such as, for example, foundations, allow aesthetics to be improved while at the same time giving the face more relief, and intensifying their colour.

These products have varied textures ranging from fluid to solid and generally contain pulverulent dyestuffs. One of the difficulties encountered by users is that of being able to spread the composition, for example the foundation, uniformly over the entire surface of the face, so as to distribute the product uniformly. Compositions with very thick or solid textures are difficult to spray on account of their high viscosities. Compositions with fluid textures are not always suitable for obtaining a uniform makeup result, since they do not leave any visible marks on the skin, especially on account of their poor spraying over the entire surface of the face to be made up.

To answer these problems, it has been proposed to spray makeup compositions using a gas liquefied under pressure, which generates an aerosol. Such gases generally comprise volatile organic compounds (VOCs).

The introduction of new legislation is tending towards imposing a reduction in the amount of volatile organic compounds (VOCs) released into the atmosphere by aerosol-generating gases.

To achieve this reduction, a non-VOC propellent gas such as HFA 152a may be used in partial or total replacement for the propellent gases usually used. However, the use of this type of gas is not permitted in all countries.

Another means of limiting the use of VOCs is to not use propellent gas, by making use of a spray device equipped with a mechanical pump. The company Procter & Gamble has proposed, for example, in its patent applications WO 2001/12137 and WO 2001/12138, an electrostatic spraying system not requiring any propellent gas. This type of system has the drawback of not making it possible to spray compositions comprising water. This is an inconvenience when it is desired to convey water-soluble active agents.

Moreover, the presence of pulverulent materials such as pigments or fillers, which are common in cosmetic compositions, has the drawback of destabilizing the compositions, especially emulsions, and of significantly increasing the viscosity of the phase that comprises them. Specifically, in cosmetic products, it is necessary for the particulate phase to be uniformly dispersed in the composition, in order for the product, especially a makeup product, to be able to be deposited uniformly on the keratin materials. The more viscous the compositions, the more the particulate phase can be dispersed stably and homogeneously. Increasing their viscosity makes these compositions difficult to spray.

In addition, certain spraying systems do not allow the diffusion of these pulverulent particles, which may jam the diffusion head.

There is thus a need for a cosmetic product comprising pulverulent particles, which can be applied uniformly to the skin, including during their use on a large body surface.

### SUMMARY OF THE INVENTION

The inventors have shown that it is possible to obtain satisfaction in these terms by spraying a composition having a viscosity of greater than 5 mPa·s and comprising pulverulent particles, using a piezoelectric spraying system.

Such a system makes it especially possible to obtain a homogeneous, natural makeup result that does not highlight the relief imperfections of the skin.

In particular, according to a first aspect, a subject of the invention is a cosmetic assembly comprising:
i) a cosmetic or dermatological composition contained in a reservoir, the said composition being liquid and comprising, in a physiologically acceptable medium, at least one pulverulent phase, and the said composition having a viscosity ranging from 5 to 500 mPa·s,
ii) a device for spraying the said composition, comprising a sonotrode (82) coupled to a piezoelectric transducer and whose ejection surface is fed with composition via a hollow tube in fluid coupling with the reservoir and with the sonotrode.

According to a second aspect, a subject of the invention is also a process for making up the skin, comprising at least one step of spraying a cosmetic or dermatological composition as defined previously using the device mentioned previously.

According to a third aspect, a subject of the invention is also the use of an assembly as described previously, for obtaining a homogeneous, natural deposit, especially of makeup, which does not highlight the relief imperfections of the skin.

### BRIEF DESCRIPTION OF THE DRAWINGS

Various objects features and advantageous of the present invention are illustrated in the attached figures wherein:

FIG. 1 schematically shows, in elevation, an example of a spraying device made in accordance with the invention;

FIG. 2 shows the device of FIG. 1 with the product cartridge in place, ready for spraying;

FIG. 3 shows the device of FIG. 1 with the trapdoor for access to the housing receiving the open cartridge, awaiting the insertion of the cartridge on the case;

FIG. 4 is a partial schematically view, in exploded perspective, of the device of FIGS. 1 to 3;

FIG. 5 shows in partial schematic perspective, the spraying assembly;

FIG. 6 is a partial schematic longitudinal cutaway view of the spraying assembly of FIG. 5;

FIG. 7 shows, in isolation, the transducer support;

FIG. 8 shows, in isolation, in perspective, the sonotrode;

FIG. 9 is an elevated view of the sonotrode;

FIG. 10 is a longitudinal cutaway view of the sonotrode along X-X of FIG. 9;

FIG. 11 shows in perspective one implementation variant of the sonotrode;

FIG. 12 is a schematic and partial longitudinal cutaway view of a spraying head comprising the sonotrode of FIG. 11; and

FIG. 13 shows schematically, in perspective, the heating resistance of the heating device.

### DETAILED DESCRIPTION OF THE PREFERRED EMBODIMENTS

### Piezoelectric Spraying Device

One subject of the invention is a cosmetic assembly comprising a liquid cosmetic or dermatological composition contained in a reservoir and a device for spraying the said composition, comprising a sonotrode (82) coupled to a piezoelectric transducer and whose ejection surface is fed with composition via a hollow tube in fluid coupling with the reservoir and with the sonotrode.

For the purposes of the present patent application, the term “piezoelectric spraying system” means a system that nebulizes a liquid under the action of ultrasonic energy of suitable frequency and power, this energy being produced by a piezoelectric material (transducer) excited by a high-frequency electrical signal.

According to a first embodiment, the piezoelectric spraying device may comprise:
a perforated membrane, the perforations of the membrane enabling communication of the interior of the container with the external environment,
an actuator to make the membrane vibrate,
a means for bringing the liquid cosmetic composition contained in the container into contact with an inner surface of the membrane, the cosmetic composition, under the effect of the vibrations of the membrane, flowing through the perforations up to the outer surface of the membrane, where it emerges in the form of droplets.

The perforations of the membrane preferably have an inverse conicity, i.e. a cross-sectional surface that is greater on the outer surface of the membrane, facing the external environment, than on the inner surface, facing the interior of the container.

The spraying device may also comprise a pressure shift means, as described in patent application WO 95/15822, which provides a reduced pressure to the liquid in contact with the inner surface of the membrane. The reduced pressure may vary from zero pressure up to the pressure at which the air is sucked through the perforations of the membrane in contact with the composition.

Preferably, the perforations, on the outer surface of the membrane, do not touch each other.

Preferably also, the actuator is a piezoelectric actuator, for example designed to make the membrane vibrate over a frequency range extending from 20 kHz to 7 MHz. The energy required to operate the piezoelectric actuator may be obtained by means of an electrical generator, for example an electrical cell, a battery or a photovoltaic cell that may optionally be coupled to an electronic circuit.

In the spraying device defined above, the means for bringing the liquid cosmetic composition to the surface of the membrane may comprise a feed mechanism by capillary action, or alternatively a feed mechanism with a bubble generator or a membrane-, piston- or gear-type peristaltic pump. Such mechanisms are described, for example, in international patent application WO 95/15822.

According to one particular embodiment of the invention, all the perforations have an inverse conicity, or, conversely, the membrane furthermore comprises perforations of normal conicity.

For the purposes of the present invention, the expression “perforations of normal conicity” means perforations whose cross-sectional surface is smaller on the outer surface of the membrane, facing the external environment, than on the inner surface, facing the interior of the container.

When perforations of normal conicity are present, they are preferably arranged around and to the exterior of the perforations of inverse conicity.

The means for bringing the liquid cosmetic composition to the surface of the membrane may be designed to bring the said composition to the inner surface of the said membrane, or, conversely, they may be designed to bring the said composition to the outer surface of the said membrane. Such variants of the spraying device are described, for example, in international patent application WO 95/15822.

By way of example, the membrane may be formed from a circular disc 8 mm in diameter, of electroformed nickel 70 μm thick having a plurality of perforations. The perforations may have a cross-sectional surface in the form of a circular disc whose diameter ranges from 4 to 150 μm on the outer surface of the membrane, facing the external environment, and on the inner surface, facing the interior of the container, a cross-sectional surface in the form of a circular disc whose diameter ranges from 2 to 50 μm, for example from 10 to 20 μm.

During the use of the device, the cosmetic composition emerges in the form of droplets whose mean diameter is preferably between 20 and 100 μm and even more preferably between 30 and 60 μm.

Technologies corresponding to this device have especially been described in patent applications WO 93/10910, U.S. Pat. No. 5,487,378, FR-A-2 665 572 and U.S. Pat. No. 4,533,082; U.S. Pat. No. 5,518,179 and U.S. Pat. No. 6,113,001.

According to a second embodiment, the ultrasonic spraying device may comprise a micro-machined substrate, a cavity in the substrate to contain the liquid substance to be sprayed, means for supplying liquid in the cavity of the substrate and means for expelling the liquid that is vaporized in the form of monodispersed droplets under the action of the vibrations.

The expulsion means are constituted of at least one micro-machined channel in the substrate, which communicates with the cavity. For example, the substrate is made of silicon. The pressure-wave generating device is, for example, bonded under the cavity. The generated pressure wave allows the expulsion of an amount of liquid contained in the cavity through the micro-machined channels. The amount of liquid expelled in the form of fine droplets depends on the pressure wave generated, for example, by a ceramic of piezoelectric type.

By means of such a device, it is possible to determine the exact amount of liquid sprayed.

Technologies corresponding to this device have especially been described in patent application EP 1 149 602.

According to a third embodiment, the ultrasonic spraying device may use a coupler (horn) to mechanically transmit the vibration.

In particular, the ultrasonic spraying device may be an ultrasonic oscillating system comprising:
a coupler of conical shape (also known as a frustum),
a piezoelectric oscillator, and
a circular resonance plate.

The coupler of conical shape (frustum) preferably comprises two circular surfaces—one of large cross section, the other of smaller cross section—and a conical surface.

As regards the piezoelectric oscillator, it is in the form of a disc fixed onto the circular surface of larger cross section of the coupler, and is provided with two circular electrodes fixed onto each of its surfaces. A conductive supply wire is attached to each of the electrode plates. The piezoelectric oscillator generates the vibrations.

The resonance plate, made of the same material as the coupler, forms an integral part of the circular surface of smaller cross section of the coupler.

A gulley is formed on the conical surface of the coupler to allow a support member to be adapted onto the said coupler. The support member makes it possible to stabilize the entire ultrasonic oscillator system, while at the same time allowing it a certain amount of flexibility so as not to impair the vibrations. The support member has an orifice through which passes air blown by means of a fan. The liquid to be sprayed is delivered via a supply channel on the surface of the circular resonance plate, and the sprayed liquid particles are entrained by the blown air.

Technologies corresponding to this device have especially been described in patent applications WO 91/16997, U.S. Pat. No. 4,474,326 and FR 2 285 930.

In particular, the preferred spraying device according to the invention comprises a hollow tube connected to a channel that at least partially crosses the sonotrode and that opens onto an end flange defining a surface for ejection of the composition in the form of droplets, the channel opening onto the said ejection surface a non-zero distance from a peripheral edge of the said surface, and having a circular cross section, over its entire length.

In particular, the sonotrode is of longitudinal axis X, and the channel opens onto the ejection surface along the same axis X.

In this embodiment, the channel is rectilinear along the axis X.

The invention makes it possible to obtain a spray that gives satisfactory results.

The invention especially makes it possible to have relatively high spraying efficacy.

During oscillations, the flange may become deformed by changing the shape of the ejection surface, which may go, for example, from flat when at rest to forwardly concave or convex. The amplitude of forward or backward bending may be greater than or equal to 5 μm relative to the resting state, for example between 5 μm and 25 μm relative to the resting state, i.e. a total amplitude of from 10 to 50 μm.

The minimum thickness of the end flange in the region of ejection of the product particles is, for example, between 0.4 and 0.6 mm, better still between 0.45 and 0.55 mm and is preferably 0.5 mm.

The ejection of the droplets of product may take place over the entire circumference of the end flange, which contributes towards obtaining a homogeneous spray.

According to another of its aspects, a subject of the invention is a device for spraying a cosmetic or dermatological product, comprising a sonotrode and a transducer coupled to the sonotrode, the sonotrode having an end flange defining a surface for ejection of the product particles, the sonotrode also comprising a portion of decreasing diameter extended by a cylindrical portion (also known as the spout) connected to the end flange,

the ratio transducer diameter/diameter of the cylindrical portion being less than or equal to 4.5, better still 4, even better still 3.7, and preferably greater than or equal to 3 and more preferably between 3.5 and 3.7, and/or
the ratio diameter of the flange/diameter of the cylindrical portion being between 7/6 and 13/4, and/or the ratio diameter of the flange/thickness of the flange being between 70/6, for example 12, and 130/4, for example 32.

These geometrical characteristics lead to particularly satisfactory results.

The flange may have a larger transverse dimension of less than or equal to λ/4, where λ is the wavelength in the material of the sonotrode of the ultrasonic wave.

The length of the sonotrode, between the face of the sonotrode that is in contact with a transducer serving to set the sonotrode vibrating and the ejection surface, may be less than or equal to λ.

The channel for supplying the product may have a narrowed portion.

The narrowed section can slow down the flow of the product and improve the spraying performance. The narrowed portion may especially make it possible to obtain a relatively homogeneous spray.

The presence of the narrowed portion facilitates the manufacture of the rest of the channel, which may have a relatively large section, which limits the pressure losses.

The narrowed portion may ensure a certain capillary retention when the device is not in use, and makes it possible to reduce the exchanges with air. The use of an obturator for the supply channel may be avoided.

The sonotrode is coupled to a transducer for transforming electrical energy into ultrasonic vibrations. The resonant frequency of the sonotrode is preferably as close as possible to that of the transducer. The coupling may be performed, for example, by bonding or screwing.

The product particles are advantageously entrained towards the region to be treated by means of a flow of air produced by at least one fan. The air flow rate is, for example, between 4 and 7 m³/h and better still between 5.5 and 6.5 m³/h.

In one implementation example, the narrowed portion opens onto the ejection surface. The narrowed portion may have a constant cross section over a distance of at least 1 mm and less than or equal to 10 mm. The length of the narrowed portion is, for example, less than or equal to 7 mm and better still between 1 mm and 5 mm, for example 2.5 mm. The narrowed portion may have a constant cross section from the end where it opens onto the ejection surface up to the opposite end.

The narrowed portion advantageously has a circular cross section, which facilitates its production.

The channel may have a circular cross section, over its entire length.

The channel is advantageously rectilinear, of the same longitudinal axis as the sonotrode. The narrowed portion may have a smaller cross section of less than or equal to 0.8 mm². The narrowed portion may especially have a diameter of less than or equal to 1 mm, for example between 0.4 mm and 0.8 mm, preferably in the region of 0.6 mm.

The channel may have a larger cross section of greater than or equal to 0.8 mm².

The channel may have, outside the narrowed portion, a diameter of between 1 mm and 2 mm, for example in the region of 1.5 mm, or even greater, especially when the transducer is fixed by bolting onto the sonotrode.

The ratio length of the narrowed portion/total length of the sonotrode channel may be between 0.04 and 0.4.

The surface area ratio largest cross section of the channel/narrowest cross section of the channel may be between 1 and 25 and especially between 4 and 10, for example between 6 and 6.5.

The channel may feed the ejection surface via a single outlet orifice, which may be located at the centre of the ejection surface. This embodiment is a preferred one.

The sonotrode may be made as a single block with a tip for connection to a tube for feeding with product from the channel. This feed tube may be a flexible pipe, which allows the pipe to be used in a peristaltic pump. The channel may also be connected to the feed pipe by other means, for example by means of a tip inserted into the sonotrode.

The tip, for example having a circular shape, may pass through the transducer.

The outside diameter of the end flange is, for example, between 7 and 13 mm, better still between 8 and 12 mm and even better still between 9 and 11 mm, and preferably in the region of 10 mm. Good results may be obtained, in one implementation example, with a diameter of 10 mm for the end flange and a minimum thickness of 0.5 mm for the flange, for a frequency of 100 kHz±10%.

The peripheral circular band of the flange where the thickness of the flange is relatively small, especially less than or equal to 0.6 mm, may have a width, measured radially, of greater than or equal to 0.2 mm, for example from 0.2 mm to 2 mm.

The end flange may comprise a circular band 0.5 mm thick extending over a width, measured radially, of at least 0.5 mm.

The sonotrode may have a portion whose outer cross section decreases in the direction of the ejection surface, especially a frustoconical portion. The angle at the peak of this frustoconical portion may be between 10° and 45°, and may especially be 30°.

The sonotrode may have a portion of cylindrical revolution, as mentioned hereinabove. The portion of decreasing outer cross section may be connected to this portion of cylindrical revolution, the portion of cylindrical revolution being intermediate between the portion of decreasing cross section, especially frustoconical, and the end flange.

The outside diameter of the portion of cylindrical revolution is, for example, between 4 and 7 mm, and may especially be in the region of 5.5 mm.

The length of the portion of cylindrical revolution is, for example, between 3 and 5 mm.

The length of the various portions of the sonotrode is preferably chosen as a function of the nominal frequency at which the sonotrode is intended to resonate, the ejection surface preferably needing to be located substantially at a vibration antinode. The distance separating the ejection face and the transducer and the diameter of the end flange may depend on the wavelength λ=c/f, where c is the speed of sound in the material at the working temperature, and f is the frequency.

The sonotrode may be machined, preferably being made of metal, especially of aluminium or of aluminium alloy, of titanium or alloys thereof, or of stainless steel, for example 316 stainless steel.

The excitation frequency of the transducer is, for example, between 30 and 200 kHz. For example, the excitation frequency may be about 100 kHz±10%. Preferably, the excitation frequency of the transducer is between 100 and 200 kHz.

The mean size of the particles of the spray depends on the frequency and on the Theological characteristics of the fluid to be nebulized. In one embodiment of the invention, the mean size is between 20 and 25 μm, especially at a frequency of 100 kHz.

The content of fine particles less than 10 μm in size may be less than 10%.

According to another of its aspects, a subject of the invention is also a device for conditioning and spraying a cosmetic or dermatological product, comprising a head as defined above.

This device may comprise a container containing the product to be sprayed. This product may be a care or makeup product, especially a foundation or a product comprising a styling agent, a self-tanning agent or an antisun composition.

The container may be in the form of a removable cartridge.

The product may be contained in a flexible bag.

The device may comprise a case with, especially at the top, a housing for receiving the abovementioned cartridge.

The flow of air directed towards the keratin materials may be heated or cooled, as the need may be.

In one embodiment of the invention, the spraying is triggered by action by the user on a control member, for instance a push-button.

Once a spraying cycle has been triggered, a spraying sequence comprising the following steps may take place:
i) switching on of a fan that creates a flow of air for entraining the product particles,
ii) after a predefined delay, starting of vibration of the sonotrode by a transducer,
iii) after a new delay, starting of a pump for feeding the sonotrode with product.

At the end of the spraying cycle, the stopping of the device may comprise, successively, the stopping of the pump, the stopping of the transducer, and the stopping of the fan.

According to another of its aspects, a subject of the invention is also a spraying device comprising a nozzle, a support arranged inside the nozzle, a sonotrode coupled to a transducer, attached by click-fastening onto the support, with interposition of a seal between a shoulder of the support and a shoulder of the sonotrode.

This aspect of the invention facilitates the mounting of the sonotrode in the device.

According to another of its aspects, a subject of the invention is also a spraying device comprising a sonotrode, a transducer of circular shape coupled to the sonotrode, the said sonotrode being made as a single block with a tip onto which is inserted a tube for feeding with product to be sprayed. This aspect of the invention facilitates the construction of the device.

According to another of its aspects, a subject of the invention is also a cosmetic treatment process, for example for the skin, especially a makeup process, or a process for treating the hair, comprising the step that consists in spraying a cosmetic product onto the human keratin materials concerned, using a spraying head as defined above.

The invention may be understood more clearly on reading the detailed description that follows, of non-limiting embodiments thereof, and on examining the attached drawings.

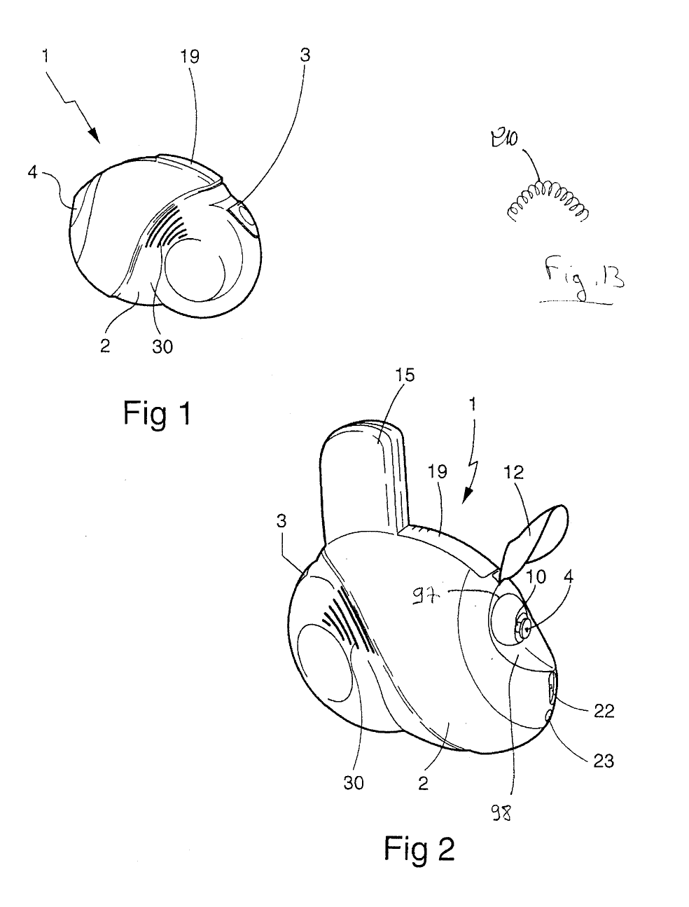

The spraying device 1 shown in FIGS. 1 to 3 comprises a case 2 that can be manipulated by the user to spray a product onto the skin or other human keratin materials, such as the lips or the hair.

The case 2 bears at the back, in the example under consideration, a push-button 3 that allows the user to start the spraying by pressing it. This push-button 3 may, as a variant, be located elsewhere and be replaced with a trigger or a sensitive button, for example.

The device 1 comprises at the front, as may be seen in FIG. 2 especially, a surface 4 for ejection of the product particles. This surface may be oriented towards the region to be treated, during use, so as to allow the product particles to be deposited on this region.

In the example under consideration, the case 2 comprises a protective lid 12 that can be folded back in front of the ejection surface 4 when not in use.

This lid 12 is, for example, articulated on the body of the case, between a lowered position in which it covers the ejection surface 4, and a raised position. In one implementation variant, the case is not provided with a protective lid or this lid is otherwise mounted in the case.

The lid 12 may extend in the continuity of the outer surface of the case 2, in the folded-back position.

The case 2 may receive a cartridge 15 containing the product to be sprayed, this cartridge 15 being introduced into a housing 17 of the case 2.

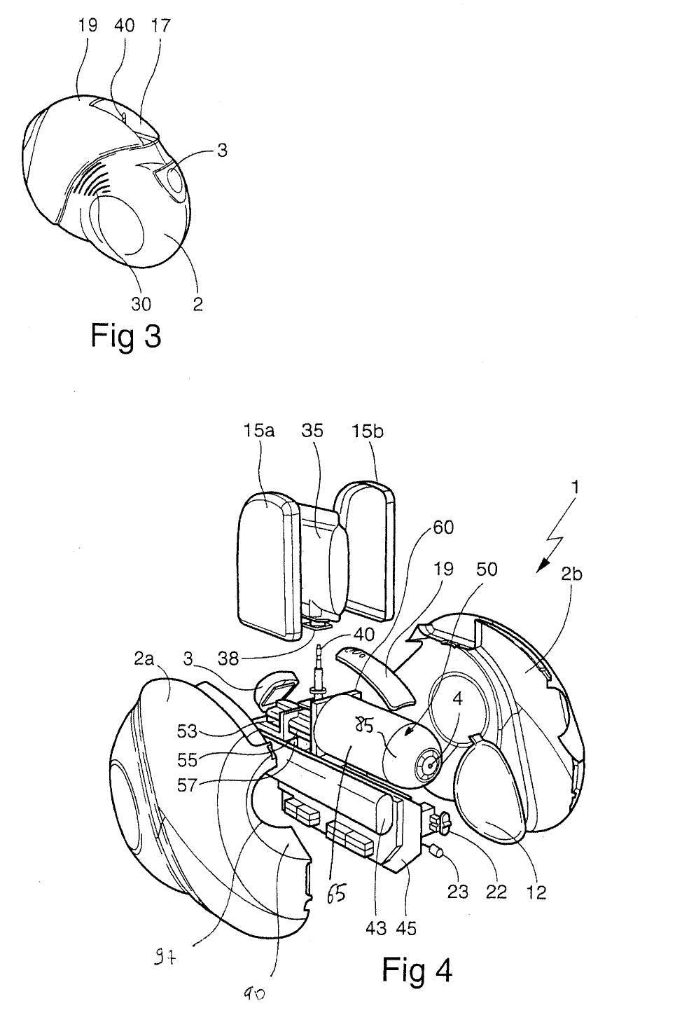

As may be seen in FIG. 3, this housing 17 may be closed off when not in use, by means of a closing flap 18.

In the example illustrated, the housing 17 is open at the top.

The closing flap 18 may be slidably mounted on the case 2. In variants that are not shown, the housing 17 is otherwise arranged on the case.

The product contained in the cartridge 15 is, for example, a foundation, a self-tanning agent, a body or face lotion, or a product containing a styling agent.

The capacity of the cartridge is, for example, between 1 ml and 100 ml and better still between 5 ml and 20 ml, especially 10 ml.

In one variant that is not shown, the device 1 may receive several cartridges containing different products or one cartridge containing several products, with a means for selecting the product to be sprayed, or, as a variant, a means for controlling the proportion of one product relative to the other in the sprayed mixture. Where appropriate, the same cartridge may contain several products with a means for selecting the product that is to be sprayed or for controlling the proportion of the various products in the sprayed mixture.

The case 2 comprises at the front, in the example under consideration, a main start/stop switch 22 and an indicating lamp 23 serving as an operating indicator. The case 2 comprises, on the sides, air inlet holes 30.

It may be seen in FIG. 4 that the body of the case 2 may be formed by assembling two half-shells 2a and 2b. These half-shells are mounted, for example, with a tight, optionally reversible adjustment, for example being click-fastened onto each other and/or maintained by screws. These half-shells 2a and 2b are made, for example, by moulding a thermoplastic material.

The cartridge 15 may comprise two half-shells 15a and 15b which are connected around a flexible bag 35 containing the product to be sprayed, this bag 35 being, for example, heat-welded onto a connecting tip 38 intended to be engaged on a suction tip 40 present in the housing 17.

The use of a flexible bag 35 allows product to be withdrawn without reuptake of air into the bag. As a variant, the cartridge may contain a reservoir other than a flexible bag, for example a movable-base reservoir.

In one implementation variant, the cartridge may comprise a visual indicator of the degree of emptiness, for example a transparent window made in one of the half-shells 15a and 15b and/or in the flexible bag 35.

The half-shells 15a and 15b are, for example, mounted with a tight, optionally reversible adjustment, for example being click-fastened and/or bonded onto each other or otherwise attached, for example being made of an opaque or transparent thermoplastic material.

The arrangement of the removable cartridge 15 in the top of the device makes it possible to benefit from a gravity effect to supply the product.

Where appropriate, a cartridge of a cleaning product may be used in replacement for a standard cartridge, to clean the device, in particular the sonotrode and the ejection surface.

The device may be proposed to the user, for example, in common packaging, with one or more cartridges containing one or more products to be sprayed and the above cleaning cartridge.

The cleaning cartridge may or may not be refillable.

The cleaning solution may be chosen from one of the solvents of the cosmetic composition in order to be compatible therewith, and may comprise, for example, isododecane, a volatile silicone, alcohol or water.

Where appropriate, the device may comprise a system for recognizing the cartridge, for example by means of an electromechanical feeler, electrical contacts or an RFID chip.

Knowledge by the device 1 of the contents of the cartridge in place may make it possible to automatically adapt operating parameters to the device of the product to be sprayed, for example the product flow rate, the excitation frequency, the air flow rate and/or the air temperature, where appropriate.

The case 2 houses a source of electrical energy 43, for example one or more accumulators or cells, and a printed circuit 45 bearing the electronic components of the device 1. These components ensure the generation of the voltage required for the spraying, the driving of the various electrical elements, and may run associated functions, for instance calculation of the amount of product remaining to be sprayed, so as to indicate to the user the need to replace the cartridge.

Opening of the case 2 by separation of the half-shells 2a and 2b may be necessary in order to replace the cells. As a variant, access to the cell compartment may be achieved without opening the case, by means of a trapdoor for access to this compartment. The spraying device 1 may comprise, where appropriate, an electrical connector for recharging an accumulator present in the case.

The case 2 also houses a spraying assembly 50 (also known as a head) and also a pump 53, this pump being connected firstly to the suction tip 40 and secondly to the spraying assembly 50 via a tube 55, which is preferably a flexible pipe.

The pump 53 is, for example, of the peristaltic type, comprising an electrical motor 57 that drives in rotation one or more rollers that press on the flexible pipe 55 to push the product towards the spraying assembly 50. The flow rate of product during functioning of the pump 53 ranges, for example, from 0.05 g/minute to 2 g/minute.

Where appropriate, the flow rate may be adjusted by the user using certain preset values.

In variants that are not shown, other types of pump are used, for example gear pumps, membrane pumps or piston pumps. Feeding by gravity or a retractable elastic bag may also be envisaged.

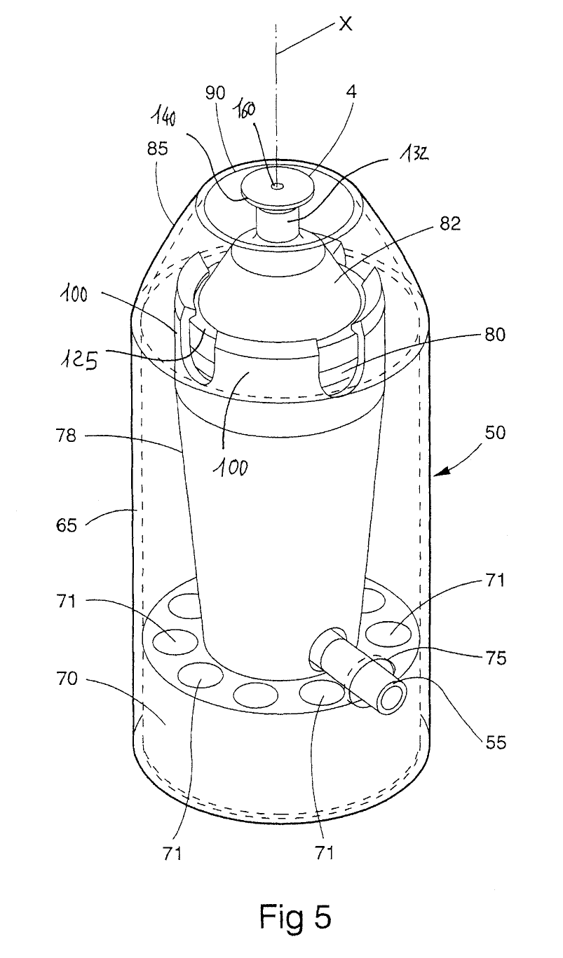

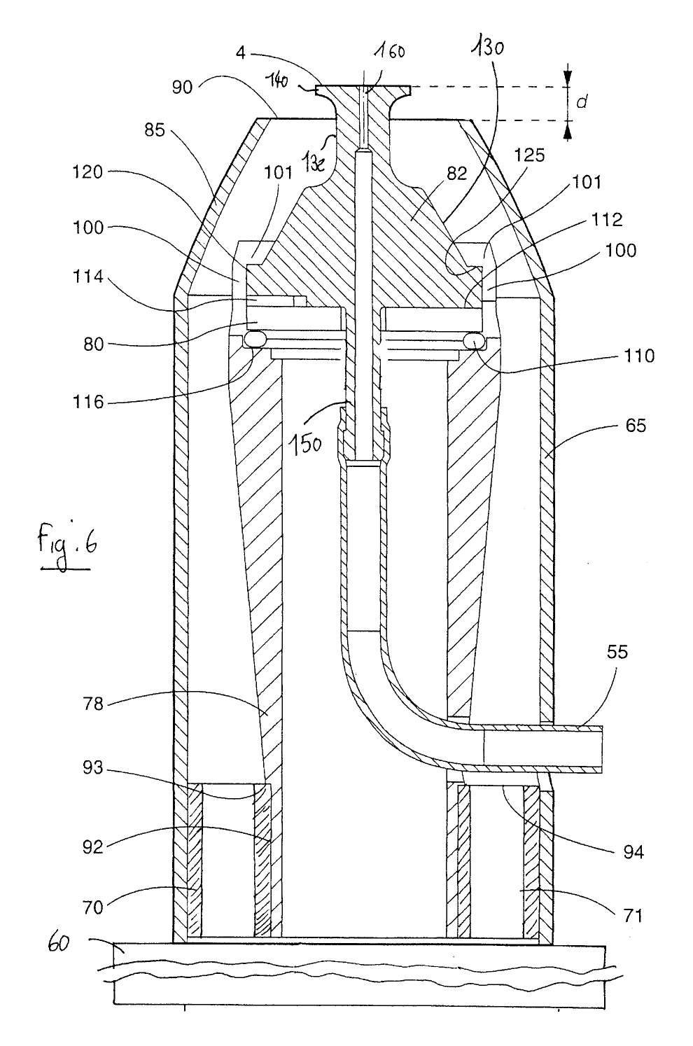

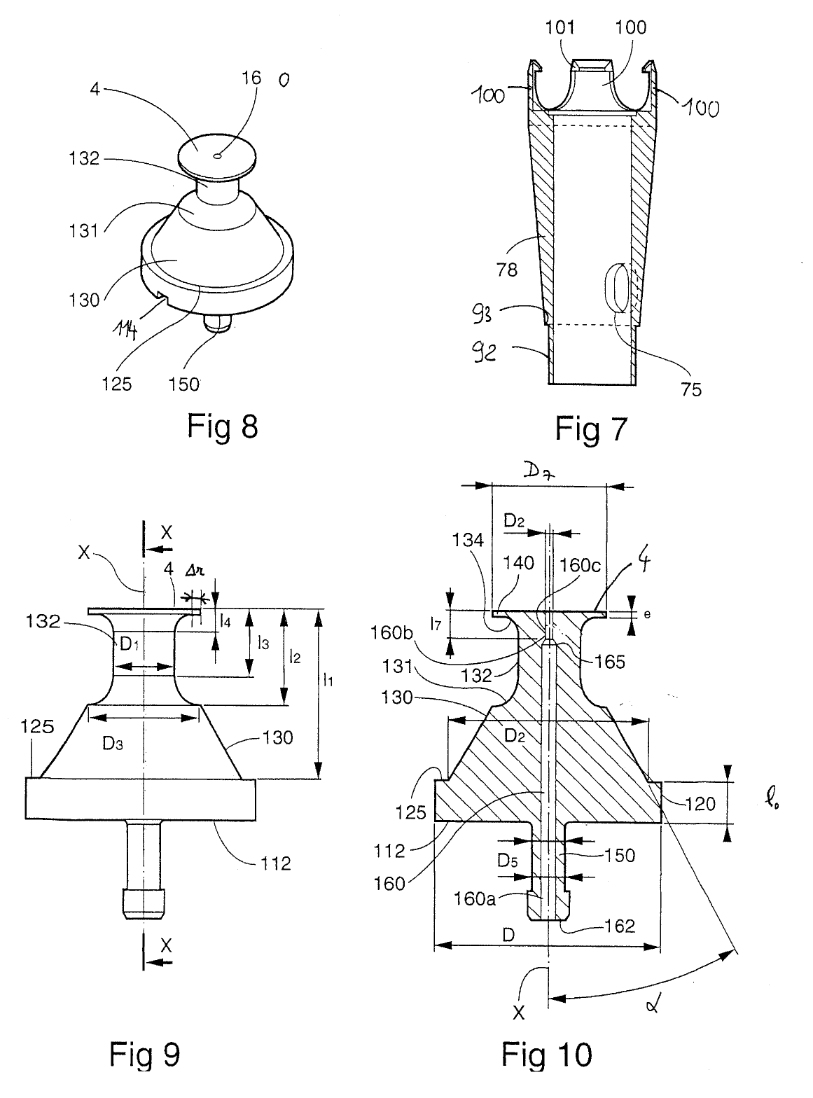

The spraying assembly 50 comprises, at the back, a fan 60, as may be seen in FIG. 4, this fan 60 not having been shown in FIG. 5 for the sake of clarity of the drawing.

The spraying assembly 50 also comprises a nozzle 65 comprising a tubular body, which is closed at the back by means of a stopper 70 provided with apertures 71 for passage of the air blown by the fan 60.

The fan 60 is, for example, fixed onto the stopper 70, for example with screws.

The axis of rotation of the fan is, for example, coincident with the longitudinal axis of the nozzle 65.

The flow rate of air injected into the nozzle 65 by the fan 60 is, for example, between 4 and 7 m³/h.

The air is sucked by the fan 60 outside the case 2 by means of the holes 30.

The fan 60 may run permanently once the user has switched on the device via the main switch 22 or, as a variant, only when the user starts spraying, by pressing the push-button 3. In one example, the running of the fan may be extended after the end of spraying for a predefined time or until a new action by the user on the device, in order to enable the user to profit from the blown air to accelerate the drying of the product deposited on the region to be treated.

Still in an embodiment of the invention, a spraying cycle controlled by actuating the push-button 3 first comprises switching on the fan, and then, after a delay of, for example, between 300 and 800 ms, for example approximately 500 ms, the spraying head is excited, and then after a further delay, for example of between 300 and 800 ms, especially of about 500 ms, the pump 53 is switched on. The spraying is stopped when the push-button 3 is released, the above steps taking place in the reverse order.

The device 1 advantageously comprises a means 200 for heating the air blown towards the surface onto which the spray is sprayed. This accelerates the drying of the product and the device is thus more comfortable to use. This may also heat the sonotrode and reduce the viscosity of the product, facilitating its flow and the spraying.

The heating means 200 comprises, for example, an electrical heating resistance 210, which may be integrated into the fan 60 or placed before or after the fan, preferably before, as illustrated in FIG. 6.

The heating means 200 is, for example, attached to the fan 60.

In one example, the heating resistance 210 is constituted of a Nichrome wire 0.51 mm in diameter and 2.8 m long, wound in the form of a spring as shown in FIG. 13, placed behind the fan 60, and fed with a power of 36 W. Such a heating resistance makes it possible to produce a flow of air at a temperature of 36° C. 10 cm from the ejection surface of the product.

The nozzle 65, the fan 60 and the heating means 200 can constitute a monobloc assembly that is easy to mount in the case 2. Furthermore, the alignment of these components makes the device relatively compact.

The temperature at which the hot air leaves the nozzle 65 is, for example, between 30 and 40° C., and ideally about 37° C.

The air outlet temperature may be adjusted, where appropriate, by virtue of the presence of a temperature sensor exposed to the flow of hot air and of an electronic regulation loop.

The device may be arranged so as to allow the user to select between functioning in which the air blown by the device is heated and functioning in which it is not.

This choice may be made, for example, by means of a selector that can be actuated by the user, this selector being controlled, for example, by a longer or shorter press on the push-button that initiates spraying.

For example, a moderate press on the push-button 3 initiates spraying with blowing of air at room temperature, and a longer press initiates spraying with blowing of hot air.

The heating device may start at the same time that the fan is switched on, and also stop at the same time, or the respective startups may be staggered over time.

The spraying device 1 may be arranged so as to go into standby mode when the push-button 3 has not been actuated for a predefined time. The return to normal functioning of the device may then require pressing of the push-button 3 or actuation of the main switch 22.

The body of the nozzle 65 is provided with a side opening 75 for passage of the product feed tube 55, and houses a support 78 that maintains a piezoelectric transducer 80.

This transducer is mechanically coupled to a sonotrode 82 for amplifying the electromechanical vibrations of the transducer 80, which are radial or longitudinal, to transmit them to the ejection surface 4, this surface being defined by an end flange of the sonotrode 82.

In the example under consideration, this sonotrode is machined in aluminium, but other materials, especially other metals or alloys, may be used.

The rear face of the sonotrode 82 is bonded to the transducer 80, but the attachment may also be made by other means, especially by mechanical means such as screwing.

The body of the nozzle 65 is, for example, of cylindrical revolution and may be moulded in a thermoplastic material.

The nozzle 65 may have, at the front, a convergent portion 85, ending with an opening 90 of the same axis X as that of the sonotrode 82. This opening 90 is circular in the example under consideration, with a diameter of between 14 and 20 mm, for example of about 16 mm.

The convergent portion 85 projects into a recess 91 of the case 2, formed by the assembly of the half-shells 2a and 2b, the base of this recess 98 defining an opening 97 that can locally follow the outer section of the nozzle 65.

In the example illustrated, the flow of air blown by the nozzle 65 is not diverted by the rest of the case, the recess 91 being sufficiently wide.

The air blown by the fan 60 leaves via the opening 90 as a flow of air generally directed along the axis X.

As may be seen especially in FIG. 6, the ejection surface 4 projects relative to the plane P of the opening 90 by a distance d. The plane P of the opening 90 is perpendicular to the axis X.

The distance d is, for example, between 2 and 4 mm, better still 2 to 3 mm and even better still between 2.2 and 2.9 mm, especially for a diameter of the opening 90 of about 16 mm. Such values make it possible to obtain a relatively homogeneous spray with little loss a distance 5 cm or even 10 cm from the ejection surface 4.

A distance d outside the above range may lead to poorer homogeneity of the spray, with, for example, a shortage at the centre and/or a less precise mark of product.

The support 78, which is, for example, moulded as a single piece from a thermoplastic material, comprises a portion 92 intended to be force-fitted into the central lumen 72 of the stopper 70, until a shoulder 93 of the support 78 abuts against the inner face 94 of the stopper 70.

The support 78 comprises, opposite the mounting portion 92, elastically deformable feet 100, for example four feet, each provided with a tooth 101 at the end, for maintaining by click-fastening the sonotrode 82 and the transducer 80, as illustrated in FIGS. 5 and 6.

Besides maintaining the sonotrode, the support 78 may also contribute towards good distribution of the flow of air inside the nozzle 65, all around the sonotrode 82.

The transducer 80, which has a circular shape, is, in the example under consideration, sandwiched between an O-ring seal 101 on the one hand, and the rear face 112 of the sonotrode on the other hand.

A hollow 114 is made in the rear face 112 to pass a first electrical supply wire of the sonotrode, contacting the face of the transducer adjacent to the sonotrode 82. The other face is electrically connected to a second supply wire.

Besides the hollow 114, the sonotrode 82 is, in the example under consideration, of symmetrical revolution about the axis X.

Various transducers may be used. A transducer 80 comprising a piezoelectric ceramic that is suitable for use in the invention is, for example, the one sold by the company Ferroperm under the reference 26132. This is a ring-shaped piezoelectric ceramic PZ26 with an outside diameter of 20 mm, an inside diameter of 3.8 mm and a thickness of 2 mm.

The O-ring seal 110 rests on a shoulder 116 of the support 78, as may be seen in FIG. 6, and the transducer 80 rests via its face opposite the sonotrode 82 on the seal 110, close to its radially outer edge.

The seal 110 allows play-free mounting of the sonotrode 82 and the transducer 80 on the support 78.

The sonotrode 82 comprises, at the rear, a first enlarged cylindrical section 120, defining a shoulder 125 on which the teeth 101 may engage.

The sonotrode 82 extends forward, beyond the shoulder 125, via a frustoconical portion 130, which connects, via a groove 131, to a second cylindrical section 132 of axis X. This cylindrical section 132 connects via a groove 134 to an end flange 140 whose front face, which is generally perpendicular to the axis X, defines the ejection surface 4 of the product.

The diameter D of the first cylindrical section 120 is, for example, between 18 and 22 mm, for example 20 mm. This diameter D corresponds, for example, substantially to the largest diameter of the transducer 80. In one variant, the transducer 80 has a diameter of 15 mm.

The length l₀ of the cylindrical section 120 is, for example, between 1.5 and 5.5 mm, for example 3.5 mm.

The largest diameter D₂ of the frustoconical portion 130 is, for example, between 15.5 mm and 19.5 mm, for example 17.5 mm, and the smallest diameter D₃ of the frustoconical portion 130 is, for example, between 8 and 12 mm, for example 10 mm. The angle α at the top of the frustoconical portion 130 is 30° in the illustrated example.

The radius of curvature of the groove 131 is, for example, between 2 and 3 mm, and is 2.5 mm in the illustrated example, and that of the groove 134 is, for example, between 1 and 2 mm, and is 1.5 mm in the illustrated example.

The distance l₁ between the shoulder 125 and the ejection surface 4, measured along the axis X, is, for example, between 13 and 17 mm, and is, for example, 14.9 mm in the illustrated example.

The distance 12 between the top of the frustoconical portion 130 and the ejection surface 4 is, for example, between 7 and 10 mm, and is 8.4 mm in the illustrated example.

The distance 13 between the rear end of the second cylindrical section 132 and the ejection surface 4 is, for example, between 4 and 8 mm, and is 5.9 mm in the illustrated example.

The distance 14 between the front end of the second cylindrical section 132 and the ejection surface 4 is, for example, between 1.5 mm and 2.5 mm, and is 2 mm in the illustrated example.

The diameter D₁ of the second cylindrical section 132 is, for example, between 4 and 6 mm, and is 5.5 mm in the illustrated example, and the thickness e of the end flange 140, measured along the axis X close to its radially outer edge, is, for example, between 0.4 and 0.6 mm, and is 0.5 mm in the illustrated example.

The diameter D₇ of the end flange is, for example, between 7 and 13 mm, and is 10 mm in the example under consideration.

The rear face of the end flange 140 ends, in the example under consideration, perpendicular to the axis X.

The thickness of the flange may be constant from its periphery over a circular band of width Δr, measured radially, of between 0.2 and 2 mm, and is 0.5 mm in the example under consideration.

The ratio D₇/D₁ is, for example, between 7/6 and 13/4, and the ratio D₇/e is between 70/6 and 130/4.

The invention is not limited to the form of end flange illustrated in the drawing, and other forms are possible, for example an elliptical form. In this case, the term “diameter” relates to that of the circle circumscribed to the flange.

The sonotrode 82 is made in the example under consideration with, at the rear, a tip 150 for connection to the feed pipe 55, the tip 150 being, for example, monolithic, made by machining with the rest of the sonotrode 82. The tube 55 is, for example, inserted by force onto the tip 150.

A product feed channel 160 crosses the sonotrode 82 along the axis X. A first portion 160a of the channel 160 extends with a constant inside diameter, from the lower end 162 of the tip 150 up to a point 165 located within the second cylindrical section 132, where this portion 160a connects with a narrowed portion 160b via a frustoconical bore 160c.

The inside diameter D₅ of the channel 160, on its portion 160a of larger diameter, is, for example, between 1 and 3 mm, and is 1.5 mm in the illustrated example, and the diameter D₆ of the narrowed portion 160b is, for example, between 0.4 mm and 0.8 mm, and is preferably 0.6 mm.

The presence of the portion 160a of larger diameter facilitates the machining of the channel 160 and makes it possible to avoid generating an excessive pressure loss. The presence of the narrowed portion 160b leads to higher performance as regards the quality of the spray formed.

The length l₇ of the narrowed portion 160b, measured along the axis X, is, for example, between 2 and 3 mm, for example 5 mm.

The transducer 80 is excited, for example, at a frequency of between 30 and 200 kHz and better still between 60 and 200 kHz, and the pump 53 delivers at the ejection surface 4, via the channel 160 passing through the sonotrode 80, the product to be sprayed.

The excitation frequency of the transducer 80 may be constant or, better still, may be slaved so as to obtain the maximum vibration amplitude of the ejection surface and maximum spraying efficacy.

The electronic components of the device may comprise, in a conventional manner, an electronic circuit that ensures this function.

The functioning of the pump 53 may comprise, where appropriate, at the end of spraying, an inversion of the direction of rotation of the motor for a brief moment, so as to suck back the product present in the channel and reduce the risk of drying and blocking of the channel.

During the application of an electrical voltage to the transducer 80 by means of these first and second supply wires, the transducer 80 vibrates, in the example under consideration, radially relative to the axis X. The vibrations thus generated propagate with an amplification of the amplitude in the sonotrode 82 up to the ejection surface 4, which vibrates axially by bending.

Under the effect of the vibrations, the end flange 140 becomes deformed, and the oscillations of the flange 140 bring about the ejection of droplets of product over its entire circumference.

The mean size of the emitted droplets is, for example, between 20 and 30 μm.

The ejected droplets of product are entrained by the flow of air leaving the opening 90 towards the surface to be treated, and reach this surface in the form of droplets.

The product flow rate is, for example, between 0.5 g/minute and 10 g/minute as a function of the viscosity of the product to be nebulized.

A device according to the invention may make it possible to form, in one example, a solid, uniform mark of product of about 40 mm, on the region to be treated.

In the example of FIG. 10, the particular values of the dimensions of the sonotrode have been given for a frequency f of 100 kHz.

For a different frequency f′, the dimensions may be modified by a factor f/f′, to a first approach.

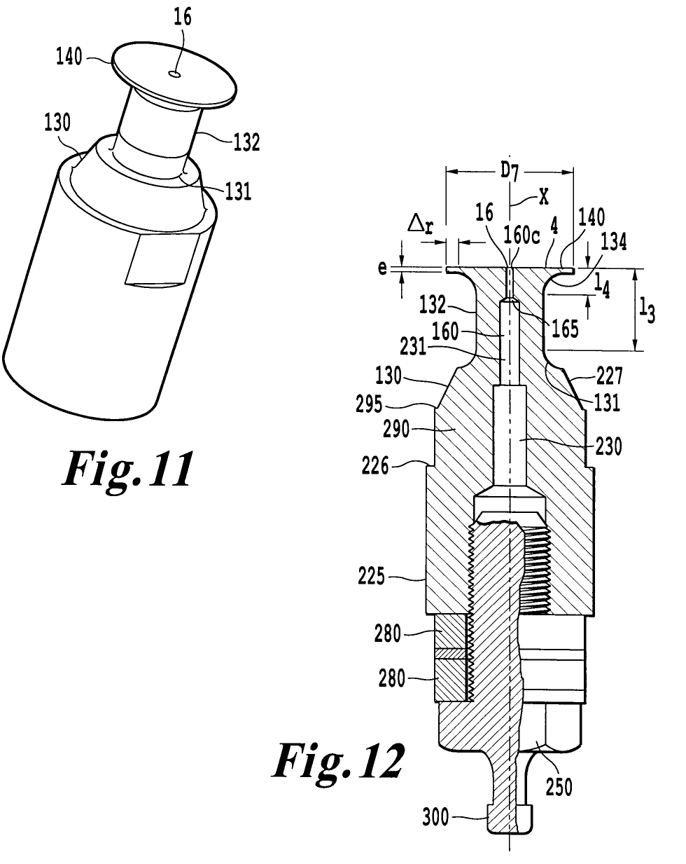

FIG. 11 shows an implementation variant of the sonotrode, intended to operate at a frequency of 60 kHz. This sonotrode differs from the one illustrated in FIG. 10 in its dimensions and in the shape of the body 290 located at the back of the cylindrical portion 132.

The sonotrode comprises inner threading 220 that allows the attachment of a bolt 250 for maintaining a vibration generator, composed, for example, of two piezoelectric ceramics 280 mounted head-to-tail.

The length l₇ of the narrowed portion 160c is, for example, 3.5 mm. The length of the cylindrical surface 225 from the end face opposite the flange 140 up to a shoulder 226 of the body 290 is, for example, 18 mm, and the distance from the shoulder 226 to the base 295 of a frustoconical portion 227 adjacent to the cylindrical portion 132 is, for example, 7 mm.

The housing 229 receiving the bolt 250 is in communication with two successive bores 230 and 231 of decreasing respective diameters, for example equal to 4 and 2.5 mm, respectively.

A central lumen passes through the bolt 250 to allow the product to be sprayed to be conveyed, and may comprise a tip 300 for connecting the flexible tube 55.

Needless to say, the invention is not limited to the implementation examples that have just been described.

In one variant, not shown, the feeding of product is performed by a needle that directly delivers the product inside the sonotrode, set back from the product outlet orifice.

The narrowed portion of the channel may be formed not by machining the sonotrode, but by connecting thereon a flow reducer, for instance a small sleeve inserted by force into a channel of suitable diameter of the sonotrode.

The case of the device 1 may be given other forms, especially a pen form.

The case manipulated by the user may be connected, where appropriate, via an electrical cable, to a base comprising at least the power supply.

In one variant, not illustrated, the supply channel opens via several orifices onto the ejection surface. These orifices are, for example, arranged in accordance with an axial symmetry. The narrowed portion of the channel may be located before the channels that communicate with the orifices or, as a variant, each branch of the channel leading to an orifice comprises a narrowed portion.

The ejection surface of the sonotrode may have received a surface treatment intended, for example, to reduce the surface tension. This treatment may be, for example, a deposit of PTFE or a polished mirror.

Where appropriate, the device may be arranged so as to allow adjustment of the overlap d of the ejection surface 4 relative to the opening 90. This may improve the focusing of the spray.

In one variant, the device may be used for spraying a product into the atmosphere.

The expression “comprising one” should be understood as being synonymous with “comprising at least one”, unless otherwise mentioned.

The ranges of values should be understood as being inclusive of the limits, unless otherwise mentioned.

### Viscosity

The composition according to the invention is liquid. The term “liquid” means a composition that flows under its own weight.

The composition has a viscosity ranging from 5 to 500 mPa·s, preferably from 10 to 400 mPa·s, more preferentially ranging from 20 to 150 mPa·s and even more preferentially ranging from 25 to 100 mPa·s.

The viscosity is measured at 25° C. with a Rheomat 180 viscometer equipped with an MK-R-1, 2 or 3 spindle depending on the viscosity range and with the corresponding measuring cup MB-R-1, 2 or 3, at a spin speed of 200 min⁻¹, the measurement being taken 10 minutes after starting the spinning (after which time stabilization of the viscosity and the spin speed of the spindle is observed).

### Pulverulent Phase

The composition according to the invention comprises a pulverulent phase.

The pulverulent phase may especially comprise pigments, fillers and/or nacres.

According to one preferred embodiment, the pulverulent phase of the composition according to the invention comprises pigments.

The term “pigments” should be understood as meaning mineral or organic particles, which are insoluble in the liquid organic phase, and which are intended to colour and/or opacify the composition.

The pigments may be mineral or organic pigments. Pigments that may be used include metal oxides, for instance iron oxides (especially yellow, red, brown and black iron oxides), titanium dioxides, cerium oxide, zirconium oxide and chromium oxide; manganese violet, ultramarine blue, Prussian blue, cobalt blue and ferric blue, and mixtures thereof.

Iron oxide and/or titanium oxide pigments are preferably used.

The pigments may be treated with a hydrophobic agent to make them compatible with the organic phase of the composition. The hydrophobic-treatment agent may be chosen from silicones, for instance methicones, dimethicones or perfluoroalkylsilanes; fatty acids, for instance stearic acid; metal soaps, for instance aluminium dimyristate, the aluminium salt of hydrogenated tallow glutamate, perfluoroalkyl phosphates, perfluoroalkylsilanes, perfluoroalkyl-silazanes, polyhexafluoropropylene oxides, polyorgano-siloxanes comprising perfluoroalkyl perfluoropolyether groups, and amino acids; N-acylamino acids or salts thereof; lecithin, isopropyl triisostearyl titanate, and mixtures thereof.

The N-acylamino acids may comprise an acyl group containing from 8 to 22 carbon atoms, for instance a 2-ethylhexanoyl, caproyl, lauroyl, myristoyl, palmitoyl, stearoyl or cocoyl group. The salts of these compounds may be aluminium, magnesium, calcium, zirconium, zinc, sodium or potassium salts. The amino acid may be, for example, lysine, glutamic acid or alanine.

The term “alkyl” mentioned in the compounds mentioned above especially denotes an alkyl group containing from 1 to 30 carbon atoms and preferably containing from 5 to 16 carbon atoms.

Hydrophobic-treated pigments are described especially in patent application EP-A-1 086 683.

The pigments may be present in the composition according to the invention in a content ranging from 0.1% to 30% by weight, in particular ranging from 1% to 20% by weight and more preferentially ranging from 3% to 15% by weight relative to the total weight of the composition.

Besides the pigments, the pulverulent phase of the composition according to the invention may comprise fillers and/or nacres.

According to one preferred embodiment, the composition according to the invention may comprise fillers.

The term “fillers” should be understood as meaning colourless or white, mineral or synthetic particles of any form, which are insoluble in the medium of the composition irrespective of the temperature at which the composition is manufactured.

The fillers may be mineral or organic and of any form, platelet-shaped, spherical or oblong, irrespective of the crystallographic form (for example lamellar, cubic, hexagonal, orthorhombic, etc.). Mention may be made of talc, mica, silica, kaolin, polyamide (Nylon®) powders, poly-β-alanine powders, polyethylene powders, polymethyl methacrylates, polyurethane powders such as the powder of the copolymer of hexamethylene diisocyanate and of trimethylol hexyl lactone sold under the name Plastic Powder D-400 by the company Toshiki, tetrafluoroethylene polymer (Teflon®) powders, micronized wax particles, especially carnauba microwaxes such as those sold under the name MicroCare 350® by the company Micro Powders, microwaxes of synthetic wax such as those sold under the name MicroEase 114S® by the company Micro Powders, microwaxes consisting of a mixture of carnauba wax and of polyethylene wax, such as those sold under the names MicroCare 300® and 310® by the company Micro Powders, microwaxes consisting of a mixture of carnauba wax and of synthetic wax, such as those sold under the name MicroCare 325® by the company Micro Powders, polyethylene microwaxes such as those sold under the names MicroPoly 200®, 220®, 220L® and 250S® by the company Micro Powders, and those sold under the name Cerapure H5-C by the company Shamrock, or polypropylene microwaxes such as those sold under the name Mattewax by the company Micro Powders; lauroyllysine, starch, boron nitride, hollow polymer microspheres such as those of polyvinylidene chloride/acrylonitrile, for instance Expancel® (Nobel Industrie), and of acrylic acid copolymers, silicone resin powders, in particular silsesquioxane powders (silicone resin powders described especially in patent EP 293 795; for example Tospearls® from Toshiba), elastomeric polyorganosiloxane particles, precipitated calcium carbonate, magnesium carbonate, magnesium hydrogen carbonate, hydroxyapatite, hollow silica microspheres, glass or ceramic microcapsules, and metal soaps derived from organic carboxylic acids containing from 8 to 22 carbon atoms and preferably from 12 to 18 carbon atoms, for example zinc stearate, magnesium stearate, lithium stearate, zinc laurate or magnesium myristate; barium sulfate, and mixtures thereof.

According to one preferred embodiment, the composition according to the invention may comprise a polytetrafluoroethylene (PTFE) powder, a polyamide (Nylon®) powder, or a mixture thereof.

The fillers may be present in the composition according to the invention in a total content ranging from 0.1% to 20% by weight, preferably ranging from 0.2% to 15% by weight and preferentially ranging from 0.5% to 10% by weight relative to the total weight of the composition.

Besides the pigments and fillers, the particulate phase of the composition according to the invention may comprise nacres.

The term “nacres” should be understood as meaning iridescent particles, especially produced by certain mollusks in their shell or else synthesized, which are insoluble in the medium of the composition.

The nacres may be chosen from white nacreous pigments such as bismuth oxychloride, mica coated with titanium or with bismuth oxychloride, coloured nacreous pigments such as titanium mica with iron oxides, titanium mica especially with ferric blue or with chromium oxide or titanium mica with an organic pigment of the abovementioned type, and also nacreous pigments based on bismuth oxychloride.

According to one preferred embodiment, the pulverulent phase of the composition according to the invention may represent less than 30% by weight, in particular from 0.1% to 30% by weight, preferably from 1% to 25% by weight, more preferentially from 3% to 20% by weight and even more preferentially from 10% to 20% by weight, relative to the total weight of the composition.

### Fatty Phase

The composition according to the invention may comprise a fatty phase.

The fatty phase may especially comprise oils, waxes or pasty fatty substances.

### Oils

The fatty phase may comprise at least one volatile or non-volatile oil.

The term “volatile oil” means an oil that is capable of evaporating from the skin in less than one hour at room temperature and atmospheric pressure. This oil especially has a vapour pressure, at room temperature (25° C.) and atmospheric pressure (760 mmHg), ranging from 0.13 Pa to 40 000 Pa (10⁻³ to 300 mmHg), especially ranging from 1.3 Pa to 13 000 Pa (0.01 to 100 mmHg) and in particular ranging from 1.3 Pa to 1300 Pa (0.01 to 10 mmHg).

In addition, the volatile oil generally has a boiling point, measured at atmospheric pressure, ranging from 150° C. to 260° C. and especially ranging from 170° C. to 250° C.

Advantageously, the volatile oil contains one or more volatile organic oils with a flash point ranging from 30° C. to 102° C., in particular from 40° C. to 55° C. and especially from 40° C. to 50° C., and mixtures thereof.

The term “non-volatile oil” means any medium capable of remaining on the skin for several hours. A non-volatile oil in particular has a non-zero vapour pressure at room temperature and atmospheric pressure, of less than 0.001 mmHg (0.13 Pa).

As volatile oils that may be used in the invention, mention may be made of linear or branched hydrocarbon-based volatile oils containing from 8 to 16 carbon atoms, and mixtures thereof, and especially branched C₈-C₁₆ alkanes, for instance C₈-C₁₆ isoalkanes (also known as isoparaffins), isododecane, isohexadecane, for example the oils sold under the trade names Isopar® or Permethyl®, and branched C₈-C₁₆ esters, for instance isohexyl neopentanoate, and mixtures thereof. Isododecane is used in particular.

The volatile oils may also be silicone oils optionally comprising alkyl or alkoxy groups that are pendent or at the end of a silicone chain, and volatile fluoro oils, and mixtures thereof.

As volatile silicone oils that may be used in the invention, mention may be made of linear, branched or cyclic silicone oils with a viscosity at room temperature of less than 8 mm²/s and especially containing from 2 to 7 silicon atoms, these silicones optionally comprising alkyl or alkoxy groups containing from 1 to 10 carbon atoms that are pendent or at the end of each silicone. As volatile silicone oils that may be used in the invention, mention may especially be made of octamethylcyclotetrasiloxane, decamethylcyclo-pentasiloxane, dodecamethylcyclohexasiloxane, hepta-methylhexyltrisiloxane, heptamethyloctyltrisiloxane, hexamethyldisiloxane, octamethyltrisiloxane, deca-methyltetrasiloxane and dodecamethylpentasiloxane, and mixtures thereof.

The volatile fluoro oil generally does not have a flash point.

Volatile fluoro oils that may be mentioned include nonafluoroethoxybutane, nonafluoromethoxybutane, decafluoropentane, tetradecafluorohexane and dodecafluoropentane, and mixtures thereof.

The additional volatile oil may be present in a content ranging from 1% to 90% by weight, preferably from 2% to 80% by weight and even more preferentially from 3% to 65% by weight relative to the total weight of the composition.

The composition may also comprise at least one other non-volatile oil.

As non-volatile oils that may be used in the invention, mention may be made of hydrocarbon-based oils of mineral or synthetic origin, such as linear or branched hydrocarbons, for instance liquid paraffin or derivatives thereof, liquid petroleum jelly, polydecenes, hydrogenated polyisobutene such as Parleam sold by the company Nippon Oil Fats, and squalane of synthetic or plant origin; oils of animal origin, for instance perhydrosqualene; hydrocarbon-based oils of plant origin with a high triglyceride content consisting of fatty acid esters of glycerol, the fatty acids of which may have varying chain lengths, these chains possibly being linear or branched, and saturated or unsaturated, especially fatty acid triglycerides especially of 4 to 22 carbon atoms, for instance heptanoic or octanoic acid triglyceride, and capric/caprylic acid triglyceride, or alternatively hydroxylated triglycerides, such as sweet almond oil, beauty-leaf oil, palm oil, grapeseed oil, sesame oil, arara oil, rapeseed oil, sunflower oil, cotton oil, apricot oil, castor oil, alfalfa oil, marrow oil, blackcurrant oil, macadamia oil, musk rose oil, hazelnut oil, avocado oil, jojoba oil, olive oil, cereal (corn, wheat, barley or rye) germ oil, or shea butter; fatty acid esters, in particular of 4 to 22 carbon atoms, and especially of octanoic acid, of heptanoic acid, of lanolic acid, of oleic acid, of lauric acid or of stearic acid, for instance propylene glycol dioctanoate, propylene glycol monoisostearate, polyglyceryl-2 diisostearate or neopentyl glycol diheptanoate; synthetic esters of formula R₁COOR₂ in which R₁ represents a linear or branched higher fatty acid residue containing from 7 to 40 carbon atoms and R₂ represents a branched hydrocarbon-based chain containing from 3 to 40 carbon atoms, for instance purcellin oil (cetostearyl octanoate), isononyl isononanoate, isodecyl neopentanoate, C₁₂ to C₁₅ alkyl benzoate, 2-ethylhexyl palmitate, 2-octyldodecyl stearate, 2-octyldodecyl erucate, isostearyl isostearate, 2-octyldodecyl benzoate, alcohol or polyalcohol octanoates, decanoates or ricinoleates, isopropyl myristate, isopropyl palmitate, butyl stearate, hexyl laurate, diisopropyl adipate, 2-ethylhexyl palmitate, 2-hexyldecyl laurate, 2-octyldecyl palmitate, 2-octyldodecyl myristate, 2-diethylhexyl succinate, diisostearyl malate or glyceryl triisostearate or diglyceryl triisostearate; hydroxylated esters, for instance isostearyl lactate, octyl hydroxystearate, octyldodecyl hydroxystearate, diisostearyl malate, triisocetyl citrate; diethylene glycol diisononanoate; pentaerythritol esters; esters of aromatic acids and of alcohols containing 4 to 22 carbon atoms, especially tridecyl trimellitate; C₈-C₂₆ higher fatty acids such as oleic acid, linoleic acid, linolenic acid or isostearic acid; C₈-C₂₆ higher fatty alcohols such as oleyl alcohol, linoleyl alcohol, linolenyl alcohol, isostearyl alcohol or octyldodecanol; synthetic ethers containing at least 7 carbon atoms, silicone oils such as polydimethylsiloxanes (PDMS) that are liquid at room temperature, linear, and optionally phenylated, such as phenyltrimethicones, phenyltrimethylsiloxydiphenyl-siloxanes, diphenyl dimethicones, diphenylmethyl-diphenyltrisiloxanes, liquid 2-phenylethyl trimethylsiloxysilicates, optionally substituted with aliphatic and/or aromatic groups, for instance alkyl, alkoxy or phenyl groups, which are pendent and/or at the end of a silicone chain, these groups containing from 2 to 24 carbon atoms and being optionally fluorinated, or with functional groups such as hydroxyl, thiol and/or amine groups; polysiloxanes modified with fatty acids, fatty alcohols or polyoxyalkylenes, for instance dimethicone copolyols or alkylmethicone copolyols; liquid fluorosilicones; or caprylic/capric acid triglycerides, for instance those sold by the company Stearineries Dubois or those sold under the names Miglyol 810, 812 and 818 by the company Dynamit Nobel; and mixtures thereof.

The additional volatile or non-volatile oils may be present in a content ranging from 1% to 90% by weight, preferably from 2% to 80% by weight and even more preferentially from 3% to 65% by weight relative to the total weight of the composition.

### Waxes and Pasty Substances

The fatty phase of the composition according to the invention may also comprise at least one wax, at least one gum and/or at least one pasty fatty substance, which is silicone-based or non-silicone-based, of plant, animal, mineral or synthetic origin.

For the purpose of the present invention, the term “wax” means a lipophilic fatty compound that is solid at room temperature (25° C.), with a reversible solid/liquid change of state, having a melting point of greater than 30° C. which may be up to 200° C., a hardness of greater than 0.5 MPa, and having an anisotropic crystal organization in the solid state. By bringing the wax to its melting point, it is possible to make it miscible with oils and to form a microscopically homogeneous mixture, but on returning the temperature of the mixture to room temperature, recrystallization of the wax in the oils of the mixture is obtained.

For the purposes of the present invention, the waxes may be hydrocarbon-based waxes, silicone waxes and/or fluoro waxes, optionally comprising ester or hydroxyl functions. They are especially of natural origin, for instance optionally modified beeswax, carnauba wax, candelilla wax, ouricury wax, Japan wax, cork fibre wax or sugarcane wax, ceresin, paraffin wax, lignite wax, microcrystalline waxes, lanolin wax, montan wax, ozokerites, hydrogenated oils, for instance hydrogenated jojoba oil or waxes obtained from the copolymerization of ethylene, waxes obtained by Fischer-Tropsch synthesis, fatty acid esters and glycerides that are solid at 45° C., silicone waxes, for instance alkyl, alkoxy and/or esters of poly(di)methylsiloxane that are solid at 45° C., containing from 10 to 45 carbon atoms, and certain fatty acids, for instance stearic acid, myristic acid or behenic acid, and mixtures thereof.

The wax may represent from 0.01% to 20% by weight and especially from 0.1% to 10% by weight relative to the total weight of the composition. According to one embodiment, the composition may be free of waxes.

For the purposes of the invention, the term “pasty compound” means a compound with a melting point ranging from 25° C. to 60° C. and preferably from 30° C. to 45° C., and having a hardness ranging from 0.001 to 0.5 MPa and preferably from 0.005 to 0.4 MPa.

Examples of pasty fatty substances that may be mentioned include PDMSs with pendent chains of the alkyl or alkoxy type containing from 8 to 24 carbon atoms, for instance stearyl dimethicone, and especially those sold by Dow Corning under the references DC2503 or DC05514; esters of fatty alcohol or of fatty acid containing from 20 to 25 carbon atoms (a melting point especially from 20° C. to 35° C. and/or a viscosity at 40° C. ranging from 0.1 to 40 Pa·s), for instance cholesterol esters such as hydrogenated triglycerides of plant origin, for instance the hydrogenated castor oil sold under the name Thixinr by the company Rheox, polyvinyl laurate, arachidyl propionate, triisostearyl or cetyl citrate, PVP/eicosene copolymer; isopropyl lanolins with a viscosity from 10 to 25 Pa·s and preferably from 19 to 25 Pa·s and/or a melting point of 25° C. to 45° C., and mixtures thereof.

The composition of the invention may also comprise at least one alkyl, alkoxy or phenyl dimethicone, for instance the product sold under the name Abil wax 2440® by the company Goldschmidt.

### Aqueous Phase

The composition according to the invention may comprise an aqueous phase comprising water.

The water may be a floral water such as cornflower water and/or a mineral water such as eau de Vittel, eau de Lucas or eau de La Roche Posay and/or a spring water.

The aqueous phase of the composition may also comprise organic solvents that are miscible with water at room temperature (25° C.), for instance monoalcohols containing from 2 to 6 carbon atoms, such as ethanol or isopropanol; polyols especially containing from 2 to 20 carbon atoms, preferably containing from 2 to 10 carbon atoms and preferentially containing from 2 to 6 carbon atoms, such as glycerol, propylene glycol, butylene glycol, pentylene glycol, hexylene glycol, dipropylene glycol or diethylene glycol; glycol ethers (especially containing from 3 to 16 carbon atoms) such as (C₁-C₄)alkyl ethers of mono-, di- or tripropylene glycol, or (C₁-C₄)alkyl ethers of mono-, di- or triethylene glycol, and mixtures thereof.

The aqueous phase may also comprise stabilizers, for example sodium chloride, magnesium dichloride and magnesium sulfate.

The aqueous phase may also comprise any water-soluble or water-dispersible compound that is compatible with an aqueous phase, such as gelling agents, film-forming polymers, thickeners, surfactants or water-soluble active agents, and mixtures thereof.

According to one preferred embodiment, the composition according to the invention comprises less than x % by weight of gelling agents and/or thickeners. According to a more preferred embodiment, the composition according to the invention is free of gelling agents and/or thickeners.

The aqueous phase (water and optionally the water-miscible organic solvent(s)) may be present in a content ranging from 5% to 99.5% by weight, especially ranging from 10% to 90% by weight and in particular ranging from 15% to 80% by weight relative to the total weight of the composition.

### Dyes

The composition according to the invention may also comprise at least one soluble dye.

The soluble dye may be chosen from water-soluble dyes and liposoluble dyes, and mixtures thereof.

The dyes that may be used in the compositions according to the invention are “direct dyeing systems”, i.e. colouring agents or a mixture of colouring agents which, when placed in contact with the makeup support, generally the skin, instantaneously afford an associated colouring effect.

Compounds that exert a delayed colouring effect on human skin, like derivatives bearing a ketone group, for instance hydroxymethyl ketones and in particular dihydroxyacetone (DHA) and also methylglyoxane, are thus excluded from this definition. In particular, as opposed to the direct dyeing system according to the invention, these compounds cause a non-immediate colouring effect.

The water-soluble dyes according to the invention may be of natural or synthetic origin, and of plant or animal origin, in particular natural dyes of plant origin.

As illustrations of water-soluble natural colouring agents that may be used according to the invention, mention may be made particularly of caramel, beetroot juice and carmine, betanine (beetroot), cupric chlorophylline, methylene blue, anthocyanins (enocyanin, black carrot, hibiscus or elder) and riboflavin. The synthetic water-soluble dyes are, for example, FDC Red 4, DC Red 6, DC Red 22, DC Red 28, DC Red 30, DC Red 33, DC Orange 4, DC Yellow 5, DC Yellow 6, DC Yellow 8, FDC Green 3, DC Green 5 and FDC Blue 1.

The liposoluble natural dyes that may be used in the compositions according to the invention may be chosen from Sudan red, β-carotene, carotenoids, lycopene, palm oil, annatto, Sudan brown, quinoline yellow, xanthophylls (capsanthin, capsorubin or lutein), and curcumin. Examples of synthetic colouring agents that may be mentioned include synthetic liposoluble dyes, for instance DC Red 17, DC Red 21, DC Red 27, DC Green 6, DC Yellow 11, DC Violet 2 and DC Orange 5.

As other natural colouring agents that may be suitable for use in the present invention, mention may be made more particularly of anthocyans from flowers or fruit or derivatives thereof, flavonoids and tannins extracted from native or fermented plants, juglone, lawsone, extracts of fermented soybean, of algae, of fungi or of microorganisms, flavylium salts that are unsubstituted in position 3, as described in patent EP 1 172 091, extracts of Gesneria fulgens, Blechum procerum, Saxifraga and pigments that may be obtained by extraction with an organic or aqueous-organic solvent of a culture medium of micromycetes of the type Monascus monascus.

The water-soluble or liposoluble dissolved dye(s) under consideration in the context of the present invention may be present in the composition in a content ranging from 0.001% to 5% by weight, especially from 0.01% to 3% by weight and more particularly from 0.025% to 1% by weight relative to the total weight of the composition.

### Additives

The composition according to the invention may comprise at least one other common cosmetic ingredient, which may be chosen especially from antioxidants, fragrances, preserving agents, neutralizers, surfactants, sunscreens, vitamins, moisturizers, anti-wrinkle active agents, emollients, hydrophilic or lipophilic active agents, free-radical scavengers, deodorants, sequestrants and film-forming agents, and mixtures thereof.

### Galenicals

The composition according to the invention may be in various liquid galenical forms.

For example, it may be in the form of an oil-in-water, water-in-oil or multiple emulsion, an aqueous or aqueous-alcoholic solution, and even in two-phase form.

According to one preferred embodiment, the composition according to the invention is in the form of an aqueous or aqueous-alcoholic solution or in the form of an oil-in-water, water-in-oil or multiple emulsion, and more preferentially a water-in-oil emulsion.

According to one preferred embodiment, the composition according to the invention is in the form of an emulsion.

The invention is presented in greater detail in the examples hereinbelow.

### EXAMPLES

### Example 1

### Spraying of a Liquid Foundation

A liquid foundation having the composition below was prepared:

| | | mass % |
|---|---|---|
| A1 | Cetyl PEG/PPG-10/1 dimethicone sold | 1.44 |
| | under the reference Abil EM 90 by the | |
| | company Goldschmidt | |
| | Polyglyceryl 4 isostearate sold under | 0.48 |
| | the reference Isolan GI 34 by the | |
| | company Goldschmidt | |
| | Isododecane | 33.10 |
| A2 | Distearyldimethylammonium-modified | 0.48 |
| | hectorite sold under the reference | |
| | Bentone 38 VCG by the company Elementis | |
| A3 | Isododecane | 5.00 |
| | Yellow iron oxide coated with aluminium | 2.24 |
| | stearoyl glutamate | |
| | Yellow iron oxide coated with aluminium | 0.51 |
| | stearoyl glutamate | |
| | Black iron oxide coated with aluminium | 0.45 |
| | stearoyl glutamate | |
| | Titanium dioxide coated with aluminium | 6.80 |
| | stearyl glutamate | |
| A4 | PTFE | 1.10 |
| | Nylon 12 powder | 0.90 |
| B | Demineralized water | 34.3 |
| | Magnesium sulfate | 0.56 |
| | Octane-1,2-diol | 0.24 |
| | Glycerol | 2.40 |
| C | Ethanol | 10.00 |
| | TOTAL | 100% |

### Procedure

The constituents of phase A2 are weighed out in the main beaker and A2 is then added with stirring using a Moritz blender at 1500 rpm while maintaining at room temperature.

Phase A3 is prepared separately by grinding the pigments in a three-roll mill, and this phase is then added with stirring to the preceding mixture.

Phase A4 is then added with continued stirring.

To prepare the aqueous phase, the water is brought to the boiling point and the other constituents of phase B are then added.

The emulsion is prepared at room temperature. The two phases should then have a temperature in the region of room temperature.

The aqueous phase is poured into the fatty phase while gradually increasing the stirring speed of the Moritz blender up to 2500 rpm.

After the addition, the mixture is left stirring for 10 minutes, and the ethanol is then added at room temperature.

### Viscosity Measurement

The viscosity is measured at 25° C. with a Rheomat 180 viscometer equipped with an MK-R2 spindle and an MB-R2 measuring cup with a volume of 60 ml, at a spin speed of 200 min⁻¹, the measurement being taken after 10 minutes of spinning (after which time stabilization of the viscosity and the spin speed of the spindle is observed).

The viscosity of the composition of Example 1, measured according to this protocol, is 45 mPa·s.

### Spraying Tests

The composition of Example 1 is sprayed onto half of a face using apparatus as described in patent application WO 93/10910 and WO 95/15822 from The Technology Partnership PLC, as described in the present patent application from page 4, line 13 to page 6, line 29.

The same composition is applied to the other half of the face using a pad of cotton wool.

The pleasantness on application and the makeup result of the two modes of application are then compared.

Spraying of the product affords a sensation of lightness and freshness that is much less noticeable with the application by cotton wool.

Spraying avoids the fingers from becoming stained, unlike the cotton wool.

The makeup result obtained by spraying is more natural, the imperfections, in particular the marks and the pores, are less pronounced, and the result is uniform and does not require any retouching by finger. Spraying thus also makes it possible to avoid getting the hands dirty.

The composition of Example 1 may also be sprayed using the device for spraying the said composition, comprising a sonotrode (82) of longitudinal axis X, coupled to a piezoelectric transducer, this sonotrode being fed with composition via a channel that opens along the axis X onto an end flange (140) defining a surface (4) for ejection of product particles, the flange being capable of bending under the effect of the vibrations of the sonotrode so as to spray the composition in the form of droplets, as described in the present patent application from page 9, line 6 to page 34, line 6.

The same pleasantness on application and the same makeup result as in the preceding test are then obtained.

### Example 2

### Spraying of a Liquid Foundation

A liquid foundation having the following composition was prepared:

| | | mass % |
|---|---|---|
| A1 | Bis-PEG/PPG-14/14 dimethicone in | 1.80 |
| | cyclopentasiloxane sold under the | |
| | reference Abil EM 97 by the company | |
| | Goldschmidt | |
| | Isostearyl diglyceryl succinate sold | 0.60 |
| | under the reference Imwitor 780 K by | |
| | the company Sasol | |
| | Butyl paraben | 0.25 |
| A2 | Isododecane | 44.25 |
| | Distearyldimethylammonium-modified | 0.60 |
| | hectorite sold under the reference | |
| | Bentone 38 VCG by the company Elementis | |
| A3 | Cyclopentasiloxane | 5.00 |
| | Yellow iron oxide coated with aluminium | 2.24 |
| | stearyl glutamate | |
| | Yellow iron oxide coated with aluminium | 0.51 |
| | stearyl glutamate | |
| | Black iron oxide coated with aluminium | 0.45 |
| | stearoyl glutamate | |
| | Titanium dioxide coated with aluminium | 6.80 |
| | stearoyl glutamate | |
| A4 | PTFE | 1.40 |
| | Nylon 12 powder | 1.10 |
| B | Demineralized water | 30.25 |
| | Methyl paraben | 0.25 |
| | Magnesium sulfate | 0.70 |
| | Phenoxyethanol | 0.5 |
| | Octane-1,2-diol | 0.3 |
| | Glycerol | 3.00 |
| | TOTAL | 100% |

### Procedure

Phase A1 is prepared by weighing out the three constituents and the mixture is heated up to 75° C. so as to obtain a clear medium, and phase A2 is then added at room temperature with stirring using a Moritz blender at 1500 rpm.

Phase A3 is prepared separately by grinding the pigments in a three-roll mill, and this phase is then added with stirring to the preceding mixture.

Phase A4 is then added with continued stirring.

To prepare the aqueous phase, the constituents of phase B are weighed out and then brought to the boiling point.

The emulsion is prepared at room temperature. The two phases should then have a temperature in the region of room temperature.

The aqueous phase is poured into the fatty phase while gradually increasing the stirring speed of the Moritz blender up to 2500 rpm.

After the addition, the mixture is left stirring for 10 minutes at room temperature.

### Viscosity Measurement

The viscosity of the composition of Example 2, measured according to the preceding protocol, is 45 mPa·s.

### Spraying Tests

The composition of Example 2 is sprayed onto half of a face using apparatus as described in patent application WO 93/10910 and WO 95/15822 from The Technology Partnership PLC, as described in the present patent application from page 4, line 13 to page 6, line 29.

The same composition is applied to the other half of the face using a pad of cotton wool.

The pleasantness on application and the makeup result of the two modes of application are then compared.

Spraying of the product affords a sensation of lightness and freshness that is much less noticeable with the application by cotton wool.

Spraying avoids the fingers from becoming stained, unlike the cotton wool.

The makeup result obtained by spraying is more natural, the imperfections, in particular the marks and the pores, are less pronounced, and the result is uniform and does not require any retouching by finger. Spraying thus also makes it possible to avoid getting the hands dirty.

The composition of Example 2 may also be sprayed using the device for spraying the said composition, comprising a sonotrode (82) of longitudinal axis X, coupled to a piezoelectric transducer, this sonotrode being fed with composition via a channel that opens along the axis X onto an end flange (140) defining a surface (4) for ejection of product particles, the flange being capable of bending under the effect of the vibrations of the sonotrode so as to spray the composition in the form of droplets, as described in the present patent application from page 9, line 6 to page 34, line 6.

The same pleasantness on application and the same makeup result as in the preceding test are then obtained.

### Example 3

### Spraying of a Liquid Foundation

A liquid foundation having the following composition was prepared:

| | | mass % |
|---|---|---|
| | Cetyl PEG/PPG-10/1 dimethicone sold | 1.44 |
| | under the reference Abil EM 90 by the | |
| | company Goldschmidt | |
| A1 | Polyglyceryl 4 isostearate sold under | 0.48 |
| | the reference Isolan GI 34 by the | |
| | company Goldschmidt | |
| | Cyclopentasiloxane | 35.60 |
| A2 | Distearyldimethylammonium-modified | 0.48 |
| | hectorite sold under the reference | |
| | Bentone 38 VCG by the company Elementis | |
| A3 | Cyclopentasiloxane | 5.00 |
| | Yellow iron oxide coated with aluminium | 2.24 |
| | stearoyl glutamate | |
| | Yellow iron oxide coated with aluminium | 0.51 |
| | stearoyl glutamate | |
| | Black iron oxide coated with aluminium | 0.45 |
| | stearyl glutamate | |
| | Titanium dioxide coated with aluminium | 6.80 |
| | stearoyl glutamate | |
| A4 | PTFE | 1.10 |
| | Nylon 12 powder | 0.90 |
| B | Demineralized water | 20.00 |
| | Magnesium sulfate | 0.56 |
| | Methyl paraben | 0.08 |
| | Phenoxyethanol | 0.12 |
| | Octane-1,2-diol | 0.24 |
| | Glycerol | 2.40 |
| C | Cyclopentasiloxane | 21.60 |
| | TOTAL | 100% |

### Procedure

The constituents of phase A1 are weighed out in the main beaker and A2 is then added with stirring using a Moritz blender at 1500 rpm while maintaining at room temperature.

Phase A3 is prepared separately by grinding the pigments in a three-roll mill, and this phase is then added with stirring to the preceding mixture.

Phase A4 is then added with continued stirring.

To prepare the aqueous phase, the constituents of phase B are weighed out and then brought to the boiling point.

The emulsion is prepared at room temperature. The two phases should then have a temperature in the region of room temperature.

The aqueous phase is poured into the fatty phase while gradually increasing the stirring speed of the Moritz blender up to 2500 rpm.

After the addition, the mixture is left stirring for 10 minutes, and phase C is then added at room temperature.

### Viscosity Measurement

The viscosity of the composition of Example 3, measured according to the preceding protocol, is 60 mPa·s.

### Spraying Tests

The composition of Example 3 is sprayed onto half of a face using apparatus as described in patent application WO 93/10910 and WO 95/15822 from The Technology Partnership PLC, as described in the present patent application from page 4, line 13 to page 6, line 29.

The same composition is applied to the other half of the face using a pad of cotton wool.

The pleasantness on application and the makeup result of the two modes of application are then compared.

Spraying of the product affords a sensation of lightness and freshness that is much less noticeable with the application by cotton wool.

Spraying avoids the fingers from becoming stained, unlike the cotton wool.

The makeup result obtained by spraying is more natural, the imperfections, in particular the marks and the pores, are less pronounced, and the result is uniform and does not require any retouching by finger. Spraying thus also makes it possible to avoid getting the hands dirty.

The composition of Example 3 may also be sprayed using the device for spraying the said composition, comprising a sonotrode (82) of longitudinal axis X, coupled to a piezoelectric transducer, this sonotrode being fed with composition via a channel that opens along the axis X onto an end flange (140) defining a surface (4) for ejection of product particles, the flange being capable of bending under the effect of the vibrations of the sonotrode so as to spray the composition in the form of droplets, as described in the present patent application from page 9, line 6 to page 34, line 6.

The same pleasantness on application and the same makeup result as in the preceding test are then obtained.

The above written description of the invention provides a manner and process of making and using it such that any person skilled in this art is enabled to make and use the same, this enablement being provided in particular for the subject matter of the appended claims, which make up a part of the original description and including a cosmetic assembly comprising: i) a cosmetic or dermatological composition contained in a reservoir, the said composition being liquid and comprising, in a physiologically acceptable medium, at least one pulverulent phase, and the said composition having a viscosity ranging from 5 to 500 mPa·s, and ii) a device for spraying the said composition, comprising a sonotrode (82) coupled to a piezoelectric transducer and whose ejection surface is fed with composition via a hollow tube in fluid coupling with the reservoir and with the sonotrode.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted. Phrases such as “mention may be made,” etc. preface examples of materials that can be used and do not limit the invention to the specific materials, etc., listed.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. Cosmetic assembly comprising:
i) a cosmetic or dermatological composition contained in a reservoir, the composition being liquid and comprising, in a physiologically acceptable medium, at least one pulverulent phase, and the composition having a viscosity ranging from 5 to 500 mPa·s,
ii) a device for spraying the composition, comprising a sonotrode coupled to a piezoelectric transducer and whose ejection surface is fed with composition via a hollow tube in fluid coupling with the reservoir and with the sonotrode.

2. Cosmetic assembly according to claim 1, wherein one end of the hollow tube is connected to a channel that at least partially crosses the sonotrode and that opens onto an end flange defining a surface for ejection of the composition in the form of droplets, the channel opening onto said ejection surface being a non-zero distance from a peripheral edge of the said surface, and the channel having a circular cross section, over its entire length.

3. Cosmetic assembly according to claim 2, wherein the sonotrode is of longitudinal axis X, said channel opening onto the ejection surface being along said axis X.

4. Cosmetic assembly according to claim 2, wherein the flange is capable of bending under the effect of the vibrations of the sonotrode so as to spray the composition in the form of droplets.

5. Cosmetic assembly according to claim 4, wherein the thickness (e) of the flange is between 0.4 mm and 0.6 mm.

6. Cosmetic assembly according to claim 2, wherein the ratio diameter (D₇) of the flange/thickness (e) of the flange is between 12 and 32.

7. Cosmetic assembly according to claim 1, wherein the frequency of the device is between 30 kHz and 200 kHz.

8. Cosmetic assembly according to claim 2, wherein the sonotrode further comprises a portion of decreasing diameter extended by a cylindrical portion (132) that is connected to the end flange, the ratio diameter (D₇) of the flange/diameter (D₁) of the cylindrical portion being between 12 and 32.

9. Cosmetic assembly according to claim 1, wherein the composition has a viscosity ranging from 10 to 400 mPa·s.

10. Cosmetic assembly according to claim 1, wherein the pulverulent phase comprises pigments.

11. Cosmetic assembly according to claim 10, wherein the pigments are present in a content ranging from 0.1% to 30% by weight relative to the total weight of the composition.

12. Cosmetic assembly according to claim 1, wherein the pulverulent phase comprises fillers.

13. Cosmetic assembly according to claim 12, wherein the fillers are present in a content ranging from 0.1% to 20% by weight relative to the total weight of the composition.

14. Cosmetic assembly according to claim 1, wherein the composition is in the form of an aqueous solution, an aqueous-alcoholic solution, an oil-in-water emulsion, a water-in-oil emulsion or a multiple emulsion.

15. A process for applying makeup to skin comprising spraying a composition on the skin using a device according to claim 1.

16. Cosmetic assembly according to claim 1, wherein the frequency of the device is between 100 and 200 kHz.

17. Cosmetic assembly according to claim 1, wherein the composition has a viscosity ranging from 20 to 150 mPa·s.

18. Cosmetic assembly according to claim 10, wherein the pigments are present in a content ranging from 1% to 25% by weight relative to the total weight of the composition.

19. Cosmetic assembly according to claim 12, wherein the fillers are present in a content ranging from 0.2% to 15% by weight relative to the total weight of the composition.

20. Cosmetic assembly according to claim 1, wherein the composition is in the form of a water-in-oil emulsion.
